(19) United States
(12) Patent Application Publication
(10) Pub. No.: US 2008/0104620 A1
(43) Pub. Date: May 1, 2008

(54) AUDIO DEVICE WITH VERTICAL MULTI-DISC TRAYS

(76) Inventor: Justin Chi Won Kim, Great Neck, NY (US)

Correspondence Address: HyunJung Kim, c/o jWIN Electronics Corp., 2 Harbor Park Drive, Port Washington, NY, 11050-4602, US

(21) Appl. No.: 11/926,940

(22) Filed: Oct. 29, 2007

Related U.S. Application Data
(60) Provisional application No. 60/863,197, filed on Oct. 27, 2006.

(51) Int. Cl. G11B 17/03; G11B 17/04

(52) U.S. Cl. 720/600; 206/308.1

(57) ABSTRACT

An audio multi-disc player with vertical player trays is provided. The device includes an audio unit in a centrally located housing cabinet, the housing having vertically oriented right and left audio disc player trays in the same plane as the central housing. The player trays are each covered with a transparent or translucent cover or door which are separately capable of opening to a hidden position within the central audio housing, exposing either the right or left compact disc player trays for insertion, inspection or removal of discs while utilizing a minimum of ambient space for the tray and cover component of the audio device.

### CROSS REFERENCE TO RELATED APPLICATION

This application claims the benefit of co-pending provisional application 60/863,197 filed Oct. 27, 2006.

### FIELD OF THE INVENTION

The present invention relates to vertically oriented audio equipment having multiple disc trays.

### BACKGROUND OF THE INVENTION

Audio devices are available in a wide range of functional and decorative designs which impose design restrictions often requiring adaptations and improvements to achieve success. Such limitations include the availability of usable space, choices for positioning the audio device, and the use of equipment to protect the audio device, particularly tray covers for protecting CD players and compact discs.

For a vertically oriented audio device, i.e. one that may be standing upright on a flat surface such as a table top, or vertically mounted upon a wall, there may be inadequate room available for drawers to open and close or CD changer trays to have dust covers which swing open upon pivots or hinges.

Furthermore, in the case of a vertically oriented audio device having multiple disc trays arrayed symmetrically in an audio cabinet, such trays typically contain disc players or changers and it is necessary to provide convenient access to both trays. The present design provides a tray access system that allows the opposite trays to operate cooperatively.

It is therefore an object of the present invention to provide a vertically oriented audio device having a center console control area and symmetrical audio disc trays having audio disc players or changers on opposite sides of the center console. Each of the players or changers may be configured for one or more audio discs, as may be desired. Additionally, each of the opposite trays is protected by a dust or tray covers, which may be selectively operated to expose each tray for installation or removal of audio discs.

Therefore, it will be useful to provide protective tray covers which retreat upon opening within the center console of the audio device will not require the additional ambient space needed for horizontal trays or drawers, nor any of the various lifting-type tray covers seen in the prior art.

### SUMMARY OF THE INVENTION

The subject design provides an audio device such as a compact disc player having vertical multi-disc trays on the right and left sides of a centrally located audio control unit. The trays are each covered with transparent or translucent plastic covers or doors which open by sliding, one at a time, into the central audio housing to expose the right or left compact disc trays.

Each of the trays may contain one or more disc players or disc changers or combination player-changers. The audio content may be provided by compact discs, known as CDs, DVDs having audio segments, MP3 and related audio file formats particularly as recorded on compact discs having playable audio formats. For present purposes it is sufficient to collectively refer to the aforementioned grouping as compact discs or CDs.

A collection of compact disc label artwork may be readily and attractively displayed through the tint of vertical transparent covers, thus making the subject changer a part of its surrounding interior décor. One version of the present design features an implementation for arranging, spinning and reading selected CDs wherein each of the multiple CDs in the player has its own independent laser-operated reader device. Additionally, the system for opening and loading of the CD trays offers unique advantages as described below.

The design of the audio disc player with vertical multi-disc trays is simple in terms of shape, profile, footprint and engineering complexity. Production costs may be thereby minimized while customers enjoy ease of use and economical use of available space. Typically, CDs will be arranged in two columns that stand on opposite sides of the central control area. The transparent tray covers slide open and closed and, when open, they disappear into the central control area.

Because both of the tray covers do not need to be open at the same time, one parking area in the middle of the central control console is sufficient to serve the purpose. Unlike many other designs which leave tray covers or doors exposed or hinged open, the subject sliding cover remains completely inside the space defined by the case of the central audio housing without stretching out from the body, thereby minimizing the volume of space necessary to place and use the device. It is to be noted that the central control console of the audio device will deliver power and audio signals to loudspeakers in a conventional manner.

Thus, by ensuring that the selected tray cover opens into the central unit, the subject device does not require an excess of ambient space. Furthermore, the design preferably offers three equal sections that are proportional and aesthetically pleasing.

The tray cover transport mechanism includes means for mechanically transporting either cover into the central housing, one at a time. Such transport means may include a motorized flat gear or similar arrangement utilizing a switch or circuit activated servo-motor. The transport may be initiated by the user with a switch or it may automatically open to expose a disc, when programmed accordingly.

In one embodiment of the present design, a vertically oriented multi-disc audio device has a vertical center control console for operating at least a pair of audio disc players; a pair of symmetrical left and right audio player trays adjoining opposite vertical sides of the center control console and containing the audio disc players therein; a tray cover for each player tray for displaying and protecting the audio discs and audio disc players; a user operated control switch for selecting only one of either the left or right closed tray cover, where the selected tray cover may be opened to a holding position within the center control panel thereby facilitating access to the open player tray for insertion, inspection or removal of the audio discs; and where the opposite, closed cover remains in its closed position thereby protecting the opposite player, player tray and any audio discs installed therein.

Each tray cover is in the same plane as the vertical center control console and each tray cover is engaged in upper and lower parallel tracks attached to the center control console whereby the parallel tracks permit either closed tray cover, but not both closed tray covers, to slide open within the center console. Either open tray cover is relatively and unobtrusively hidden within the center control console. The open tray cover may be closed by a user selected control switch or the open tray cover may be closed by the sliding action of the opposite closed cover moving from its closed position to its new open position within the center control panel.

Each opposite cover tray assembly is operationally controlled by a motor drive assembly where the cover trays and motor drive assembly are logically controlled for opening only a single closed tray cover, or closing either open cover. For each sliding tray cover, the motor drive assembly is comprised of a motor; gear; belt and pulley arrangement.

Each opposite player tray has at least one audio disc player that that uses a reader device to play any musical audio programming conventionally found in the compact disc format. Each opposite player tray may have at least a pair of such audio disc players.

The center control panel of the audio device stands upright or is mounted in a substantially vertical orientation such that the audio discs are displayed in an elevated view, on a spindle-type player or holder having a axis perpendicular to the vertical orientation of the center control console.

Other objects, features and advantages of the present invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

FIG. 1 is a perspective view of an audio device having vertical multi-disc trays.

FIG. 2 is a front elevation view of the audio device of FIG. 1

FIG. 3 is a front view of an embodiment of the present invention with an open CD changer cover.

FIG. 4 is a schematic depiction of the center console control area and components for an embodiment of the subject audio device.

FIG. 5 is a perspective detail of left and right tray covers for an audio device cooperating with an embodiment of a control and drive mechanism which may be utilized in the subject audio device.

FIG. 6 is a bottom elevation view of the components depicted in FIG. 5.

FIG. 7 is a cross-sectional view 2.

FIG. 8 is a detail of the area encircled in FIG. 7.

FIG. 9 is a cross-sectional of the device in FIG. 3.

FIG. 10 is a detail of the area encircled in FIG. 9.

FIG. 11 is a cross-sectional view of the device in FIG. 3.

FIG. 12 is a detail of the area encircled in FIG. 11.

FIG. 13 is process flow diagram.

### DETAILED DESCRIPTION OF THE PREFERRED EMBODIMENTS

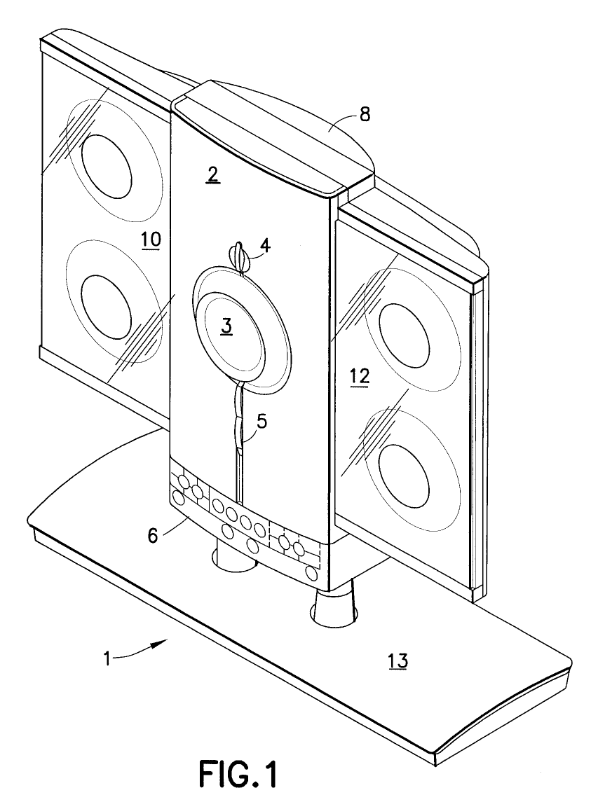

FIG. 1 has a vertically oriented audio system 1 which in a preferred embodiment is a compact disc player or similar high fidelity electronic device. In this embodiment system 1 has a center control console 2, which has a visual status indicator 3, power switch 4 and volume rocker button 5. System control panel 6 provides a variety of audio and display controls such as disc and track selection, balance and tone controls, or even radio controls when the system is so equipped. In this embodiment, system 1 is a multi-disc CD changer having a pair of individual CD players symmetrically arrayed in cabinet trays on each of the right and left sides of console 2. In this embodiment, tray cover 10 on the left and tray cover 12 on the right side of console 2 are installed in front of the vertically oriented multi-disc players. This being the normally-closed, protective position for tray covers 10 and 12. Also in this embodiment, rear cabinet case 8 may be seen. In this figure, system 1 is shown affixed to stand 13, which is suitable for placing the audio system upright on a table. In other embodiments, console 2 may be securely mounted to a wall or similar vertical surface, or stand 13 can utilize longer legs for placing the system on a floor. Audio system 1 may employ a wide variety of loudspeakers that are not shown.

Many of the components of modern audio equipment are manufactured with moldable thermoplastics having desirable properties such as durability, strength, impact resistance or flame retardance. This is particularly true for structural components of electronic devices such as panels, frames, cases, armatures, tracks, standoffs and the like. In other applications it may be desirable to utilize metal or wooden parts as well. For example, wood or metal, such as brushed aluminum, may be used for cabinets or panels and control devices such as knobs and switches. Fabrication materials are chosen upon consideration of required functional or aesthetic properties.

In audio system 1 depicted in FIG. 1, it is preferred that tray covers 10 and 12 are transparent or translucent plastic suitable for operating in a vertical orientation while protecting the multi-disc CD changers. As such, preferred tray covers may be molded, cast or sheet formed thermoplastic polymer and copolymer resins such polycarbonate, polymethyl methacrylate or a variety of modified polystyrene products and materials. Audio equipment cabinetry or components used in the subject design may be fabricated by any of several well-known methods, such as injection molding processes.

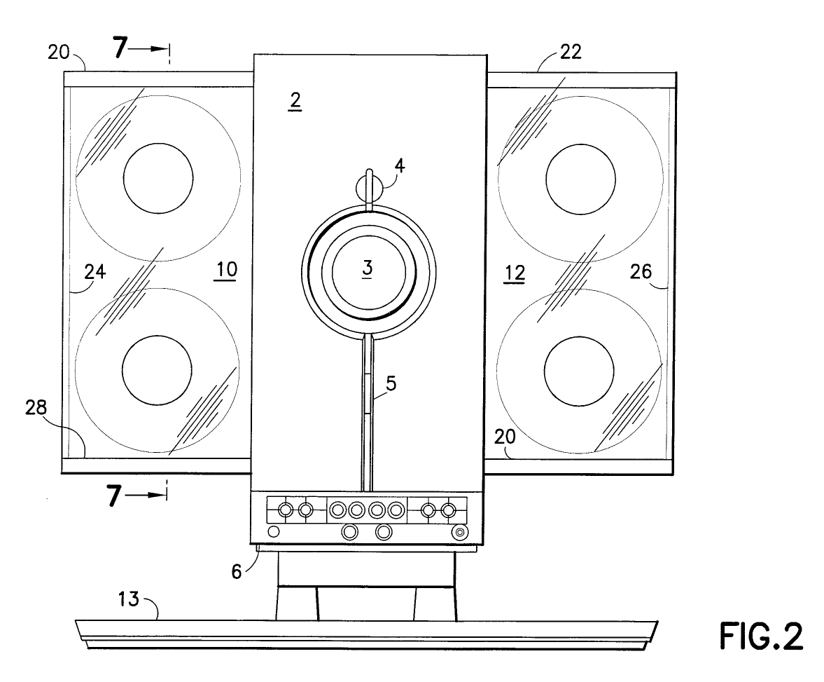

FIG. 2 depicts the system of FIG. 1 in additional detail. Vertical tray covers 10 and 12 are shown in their respective closed positions, i.e. protecting the audio discs or multi-disc CD-changers behind covers 10 and 12. As mentioned, it is preferred that covers 10 and 12 are generally transparent so that disc art may be displayed and the loaded or unloaded status of each CD player may be readily ascertained. In this embodiment it is seen that covers 10 and 12 each have a respective forward or outer edge 24 and 26 and the covers respectively traverse the front of the vertical multi-disc CD players within slots or tracks behind or within cabinet edge panels 20, 22, 28 and 30.

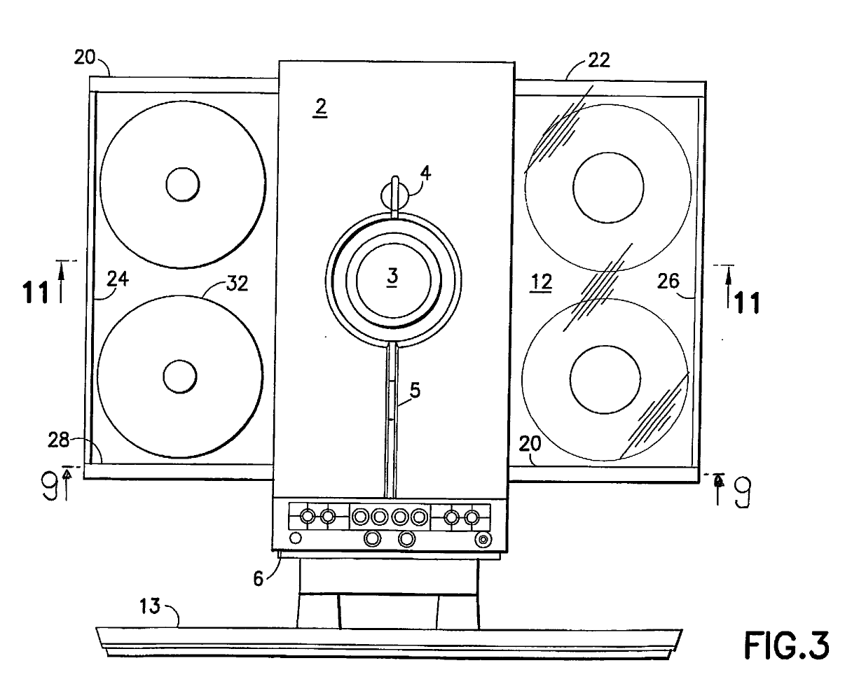

FIG. 3 is similar to the embodiment shown in FIG. 1, however only one tray cover is seen. Tray cover 10 (not seen) has advanced to its open position, by retreating within center console 2 and thereby exposing exemplary CD 32 for inspection or replacement. Tray cover 12 on the right side of console 2 remains visible in its closed position protecting the CDs or players behind it. Since tray covers 10 and 12 are positioned in the same vertical plane, only one cover at a time may be opened and located within center console 2. However, both may be closed at the same time to protect the discs and players.

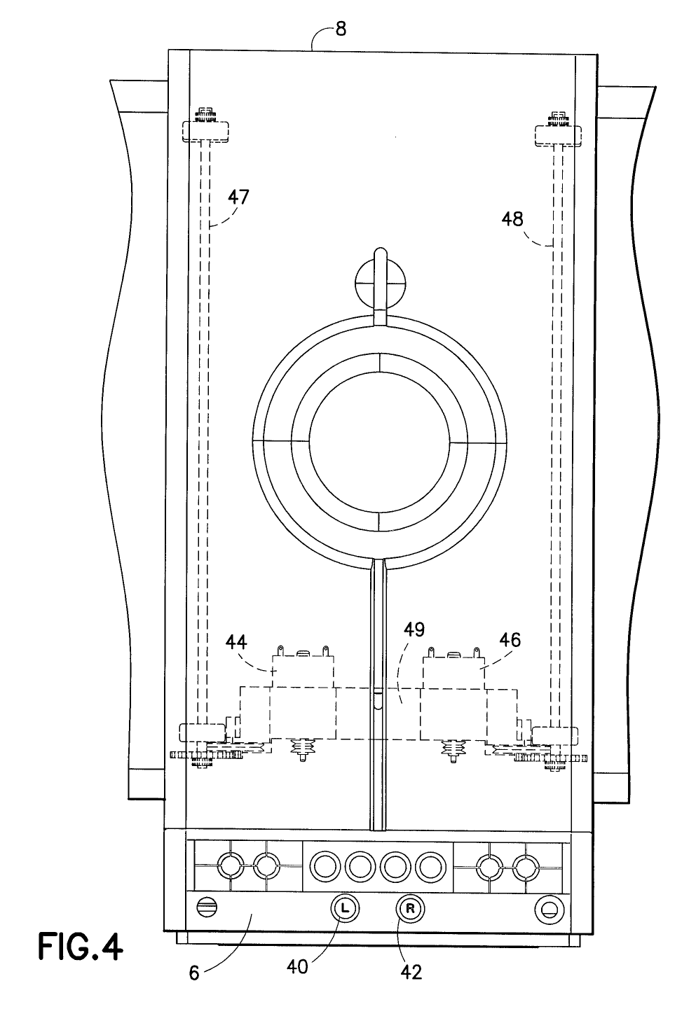

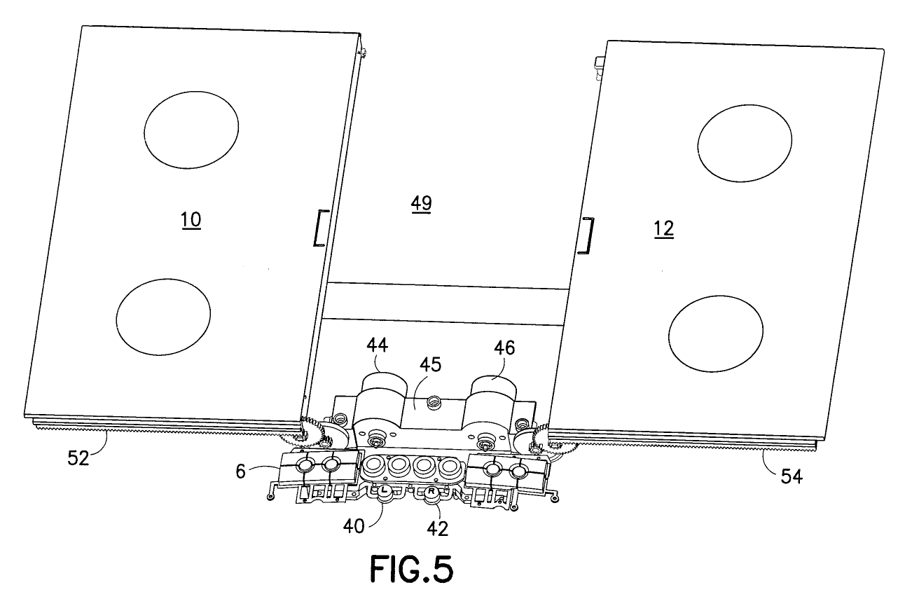

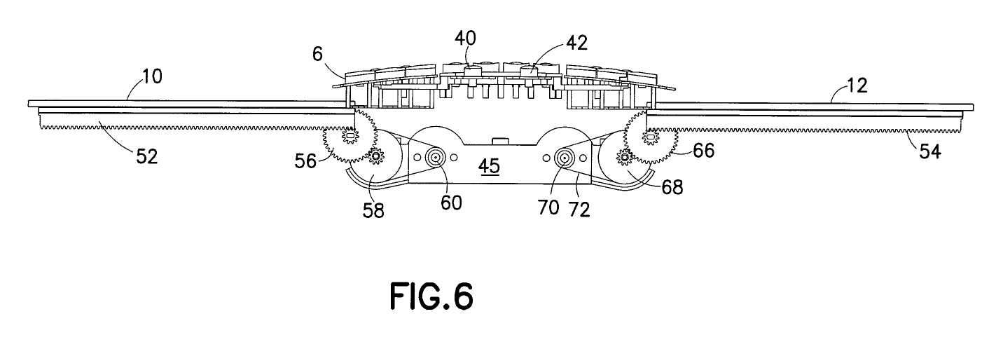

FIG. 4 is a detailed schematic and cross-section view of center control console 2 seen in FIG. 1-3. Depicted in FIG. 4 are some of the components within the center control console. In this embodiment, visual display 3 and system control panel 6 are conveniently located on the outside of the audio system console. Control panel 6 has a variety of audio device controls, particularly left and right CD tray open and close switches 40 and 42. Also within the center console is motor and control assembly 49, having in this embodiment left and right tray cover operating motors 44 and 49. The cover trays are cooperatively engaged with and operated by each respective motor. An example of such operation by a rigging and gearing arrangement is described below in connection with FIGS. 5 and 6. Also in the embodiment of the system depicted in FIG. 4, left and right spindles 47 and 48 are utilized to facilitate smooth operation of the respective tray covers.

FIG. 5 is a perspective schematic view showing the spatial relationship of certain components of a preferred embodiment of the present design. Tray covers 10 and 12 are arrayed in their closed, protective positions away from the center console of the device. In this view, each tray cover has a flat gear track 52 and 54 located at the bottom edge of each tray cover. These geared tracks are engaged with the gears, rigging and motor assemblies for opening and closing each tray cover. Motor assembly 49, having left and right motors 44 and 46, additionally has motor mount frame 45.

FIG. 6 is a bottom elevation view showing details of a gearing and rigging assembly useful for operating the tray cover in one embodiment of the subject audio device and system. Left and right open and close control switches 40 and 42 are found on system control panel 6 and respectively operate the movement of cover trays 10 and 12 with operational control logic and circuitry as described in further detail below. In this embodiment, either left tray cover 10 or right tray cover 12 may be opened at the same time, but not both. As noted, both tray covers may be closed at the same time. The mechanical operation of either cover otherwise operates similarly for each. In this embodiment, the respective motors are contained by motor mount frame 45 and will respectively operate left and right belt drive pulleys 60 and 70. Wire or belt rigging 62 and 72 may engage gears 58 and 68 and these gears may further engage gears 56 and 66. Gears 56 and 66 each respectively engage flat gear tracks 52 and 54 for the pair of tray covers 10 and 12. It will also be recognized that a wide variety of known motor-drive assemblies may be used in this design and gearing ratios will be functions of power and speed requirements for each system.

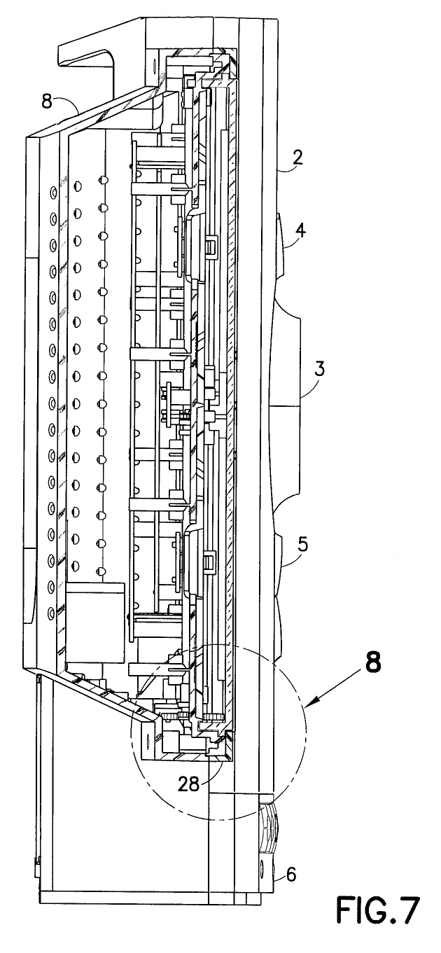

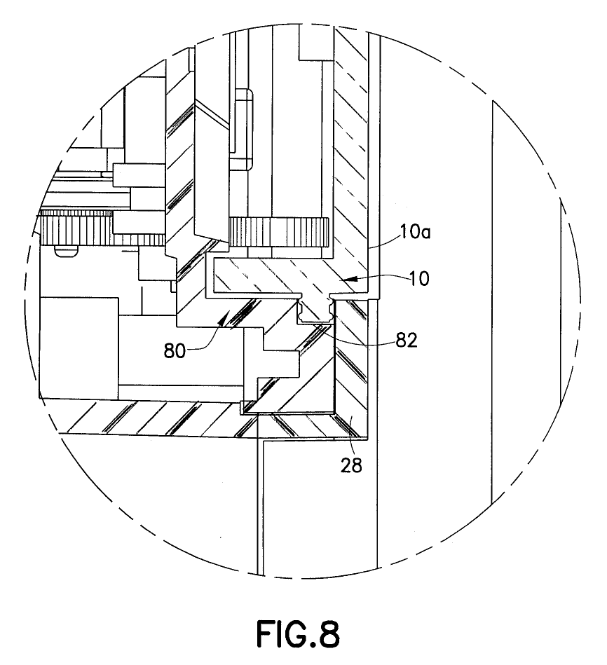

FIG. 7 is a cross-section of the device shown in FIG. 2 at the view line indicated as view 7. In this view, element numbers retain their correspondence to earlier described components. Thus the cover of center console 2 is located on the right side and has power switch 4, visual status indicator 3, volume control rocker switch 5 and sytem control panel 6. Also shown, toward the left, is a cross-sectional portion of audio device cabinet 8. A portion of cabinet front lower panel 28 is shown in greater detail in FIG. 8.

FIG. 8 is a cross-section showing additional details of the device of FIG. 7. Left tray cover 10 is shown in cross-section and has front surface 10a in this view. A portion of CD player housing 80 is shown having slot or track 82 molded therein for receiving and guiding the bottom flange of tray cover 10. Also shown is previously described cabinet front lower panel 28, seen in FIGS. 2 and 3.

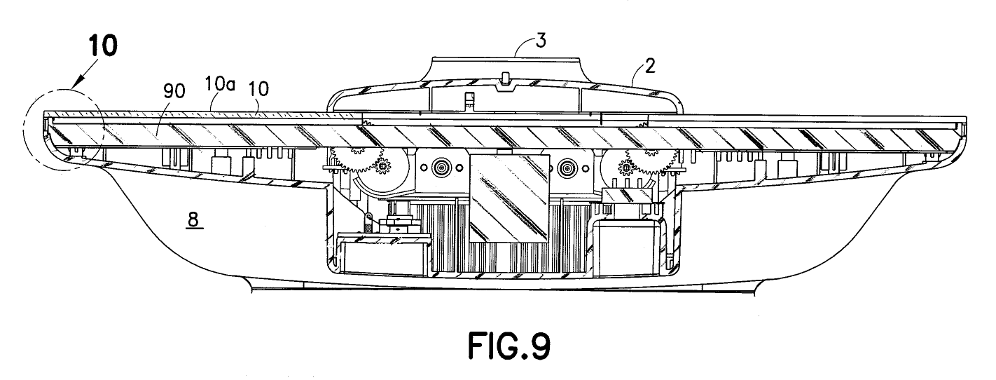

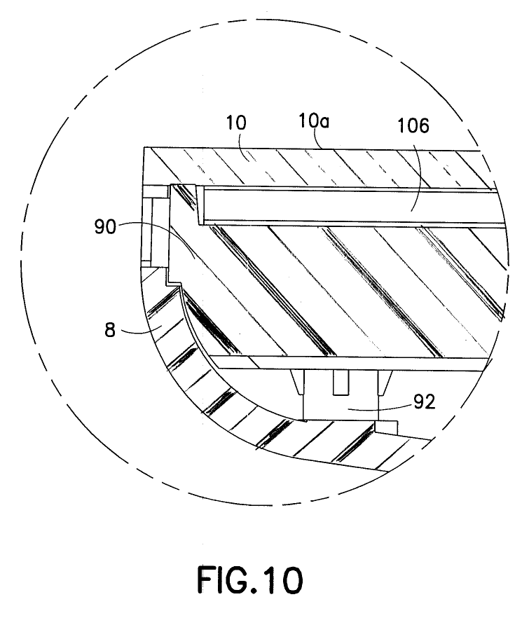

FIG. 9 is a bottom elevation cross-sectional view showing the relationship of a number of components for an embodiment of the subject audio system. A cross-section of front the front panel of center control console 2 is shown in proximity to a side view of visual control indicator 3. In this view it is seen that rear cabinet 8 encompasses the mechanical and functional components of the audio system. CD player housing 90 is shown in proximity to closed left cover tray 10, which has front surface 10a. View 10 is shown in greater detail in FIG. 10.

FIG. 10 depicts a detail of CD housing 90 in proximity to rear cabinet housing 8. In this embodiment, the cabinet housing and panel components may be attached via mechanical standoff 92, typically a molded cabinet frame component for receiving a fastener, clip or other boning mechanism to mechanically secure adjoining parts of the device. In this view, tray cover 10, having front surface 10a, is seen in its closed position. In this embodiment, tray cover 10 has a tab or flange 106, which travels in a track or guide in CD housing 90 until its range of motion is limited by a stop at the left end of such track, in this example. In other embodiments, flange 106 may be a flat gear as described above.

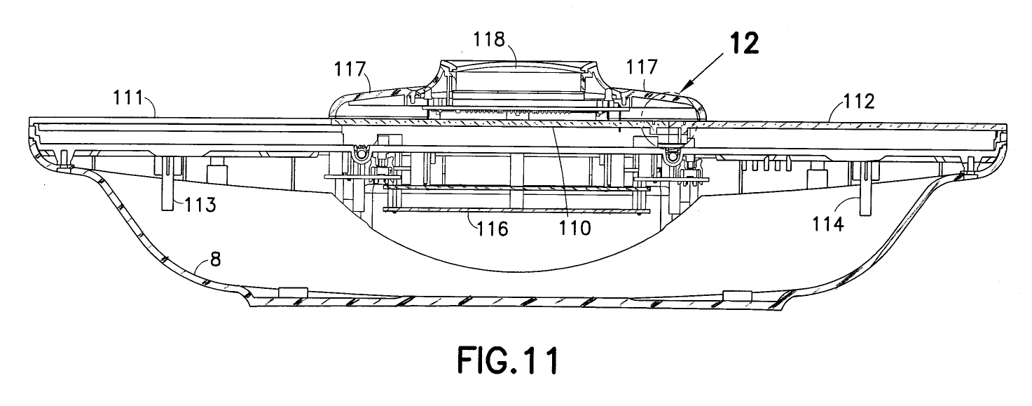

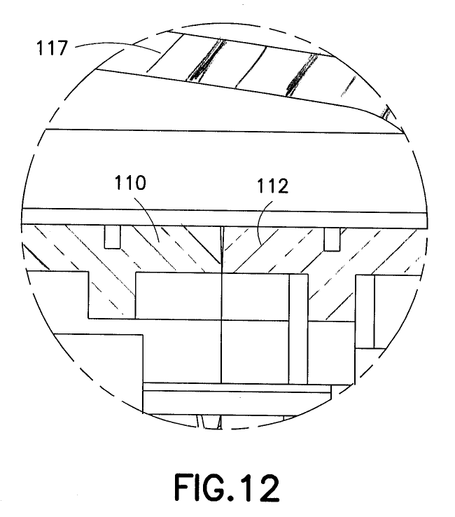

FIG. 11 is a cross-sectional view of the audio device showing additional operational details. This view shows tray cover 110 in its open position, hidden in the center console area of the audio device. Tray cover 112 remains in its closed, protective position. Reference numeral 111 indicates the open area from which cover tray 110 has been removed. View 12 is described in further detail in connection with FIG. 12. Additional features depicted in cross-section in FIG. 11 are CD player spindles 113 and 114, and motor drive frame assembly 116. Center control console 2 described in earlier figures has front panels 117 and visual display components 118 in this figure. A further cross-sectional view of rear cabinet 8 is also seen in FIG. 11.

FIG. 12 is a cross-sectional detail of a portion of FIG. 11 where open tray cover 110, which is hidden behind center control console panels 117. Open tray cover 110 abuts the edge of closed tray cover 112 that remains in its protective position. A portion of front panel 117 is seen in this view.

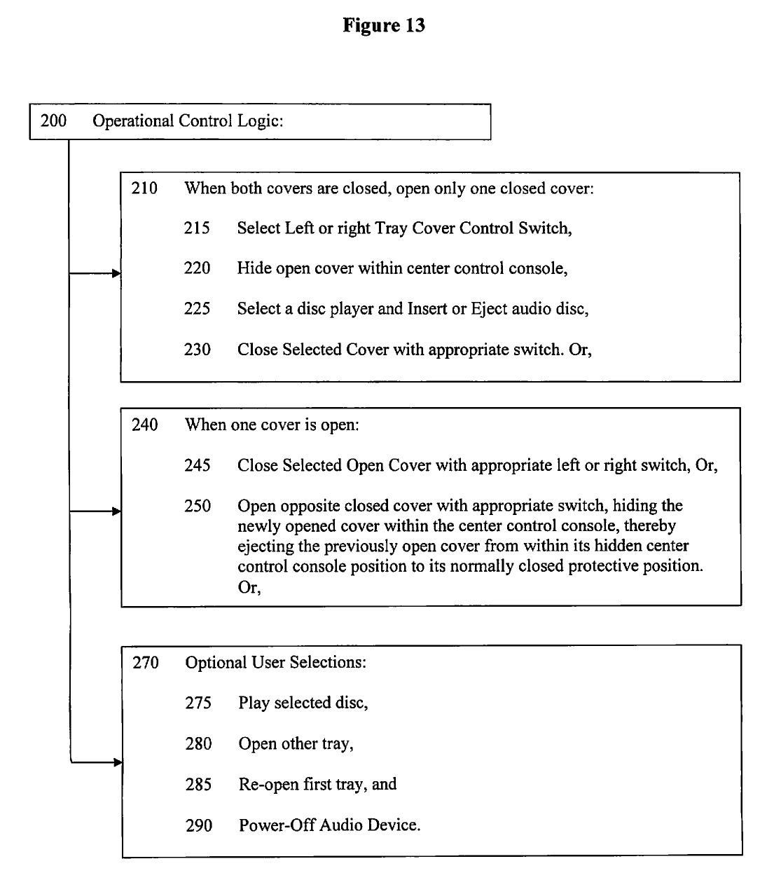

FIG. 13 provides a flow diagram for operational control logic process 200 which may be usefully employed in embodiments of the present design. In control module 210, where both covers are closed, only one closed cover may be selected and opened. In step 215, either the left or right tray cover control switch may be selected and operated, hiding the now-open cover within the center control console in step 220. In step 225, a disc player is selected and an audio disc is inserted or ejected. Thereafter, in step 230, the selected cover may be closed with its associated switch.

Alternatively, in control module 240, when one of the device tray covers is already in an open position, the user may close such open cover with appropriate left or right switches in step 245, or, in step 250, the user may open the opposite closed cover with its appropriate switch. The newly opened cover hides within the center control console, and simultaneously the previously open cover is ejected from its hidden position within the center control console, and it returns to its normally closed position.

Generally, the user of operational control logic process 200 will have a number of optional choices, in control module 270, for functions in addition to those already discussed above. For example, a selected disc may be played in step 275, a different closed tray may be opened in step 280, and the tray opened earlier may be re-opened in step 285. Step 290 indicates that the audio device may be powered off when not in use, as is typical for such devices. All of the foregoing operational control functions may be readily programmed with conventionally available integrated circuitry.

The invention now being fully described, it will be apparent to one of ordinary skill in the art that many changes and modifications can be made thereto without departing from the spirit or scope of the invention as set forth herein.

1. A vertically oriented multi-disc audio device comprising:
a vertical center control console for operating at least a pair of audio disc players;
a pair of symmetrical left and right audio player trays adjoining opposite vertical sides of the center control console and containing the audio disc players therein;
a tray cover for each player tray for displaying and protecting the audio discs and audio disc players;
a user operated control switch for selecting only one of either the left or right closed tray cover, where the selected tray cover may be opened to a holding position within the center control panel thereby facilitating access to the open player tray for insertion, inspection or removal of the audio discs; and
wherein opposite the open cover, the closed cover remains in its closed position thereby protecting the opposite player, player tray and any audio discs installed therein.

2. A device as in claim 1 wherein each tray cover is in the same plane as the vertical center control console and each tray cover is engaged in upper and lower parallel tracks attached to the center control console whereby the parallel tracks permit either closed tray cover, but not both closed tray covers, to slide open within the center console.

3. A device as in claim 1 wherein one open tray cover is relatively and unobtrusively hidden within the center control console.

4. An audio device as in claim 1 wherein an open tray cover may be closed by a user selected control switch.

5. An audio device as in claim 1 wherein an open tray cover may be closed by the sliding action of the opposite closed cover moving from its closed position to its open position within the center control panel.

6. An audio device as in claim 1 wherein each opposite cover tray assembly is operationally controlled by a motor drive assembly.

7. An audio device as in claim 6 wherein the cover trays and motor drive assembly are logically controlled for opening only a single closed tray cover, or closing either open cover.

8. An audio device as in claim 8 wherein for each sliding tray cover the motor drive assembly is comprised of a motor; gear; belt and pulley arrangement.

9. An audio device as in claim 1 wherein each opposite player tray has at least one audio disc player.

10. An audio device as in claim 9 wherein each opposite player tray has at least a pair of audio disc players.

11. An audio device as in claim 1 wherein the center control panel is standing or mounted in a substantially vertical orientation such that the audio discs are displayed in an elevated view, on a spindle-type holder having a axis perpendicular to the vertical orientation of the center control console.

12. An audio device as in claim 1 wherein the opening of a protective tray cover does not impinge upon ambient space surrounding the audio device.

13. An audio device as in claim 1 wherein the tray covers are transparent or translucent thermoplastic resin.

14. An audio device as in claim 13 wherein the tray covers are comprised of molded, cast or sheet-formed thermoplastic resin.

15. An audio device as in claim 1 wherein the audio discs have a playable audio format selected from the group consisting of audio compact discs, audio digital versatile discs, playable MP3 recordings, and CD-ROM discs having playable recordings.

16. An audio device as in claim 1 wherein the player trays comprise a molded thermoplastic cabinet frame for holding a compact disc reading player and any compact discs installed therein.

17. An audio device as in claim 1 further comprising at least one loudspeaker.

18. An audio device as in claim 1 further comprising a support stand suitable for positioning the device on a flat horizontal surface.

19. An audio device as in claim 1 further comprising a support stand and legs suitable for elevating the device above a flat horizontal surface.

20. An audio device as in claim 1 further comprising a mounting apparatus suitable for securing the device upon a vertical surface.
